(19) United States
(12) Patent Application Publication
(10) Pub. No.: US 2019/0269150 A1
(43) Pub. Date: Sep. 5, 2019

(54) Method of Making Vegetarian Protein Food Products

(71) Applicant: Frito-Lay North America, Inc., Plano, TX (US)

(72) Inventors: James Michael COOMES, Plano, TX (US); Charlene GLADDEN, McKinney, TX (US); Chien-Seng HWANG, Frisco, TX (US); Thomas Anthony TREZZA, Plano, TX (US); Yi ZHU, Plano, TX (US)

(21) Appl. No.: 15/911,428

(22) Filed: Mar. 5, 2018

(51) Int. Cl. A23J 3/26; A23P 30/25; A23L 5/10; A23J 3/16; A23J 3/18

(52) U.S. Cl. CPC A23J 3/26; A23P 30/25; A23V 2002/00; A23J 3/16; A23J 3/18; A23L 5/11

(57) ABSTRACT

Gluten and legume protein are combined with an aqueous solution and leavening agent, and processed through an extruder to obtain an expanded textured product resembling a pork snack food. The extruder is configured with a die assembly having a perforation plate with a plurality of small perforations and a forming die with a die opening that may be partitioned into a collection of smaller openings in order to produce products with desired dimensions. The viscous melt is cooked in the extruder and then forced through the die assembly. Upon exiting the forming die of the extruder, a fibrous product base is formed, expanded with air pockets. The base is then further cooked to a shelf stable moisture content, seasoned, and ready for consumption.

### BACKGROUND

### Technical Field

The present disclosure relates to a method of making a meat-free, shelf stable snack food product using plant proteins.

### Background

A chicharrón is a popular savory snack food made from a seasoned pork rind with a puffed and crispy texture. These snacks, also known as pork rinds, are often fried in oil or pork fat and considered to be low in carbohydrates but generally known to provide an incomplete source of protein. Some snack food products attempting to mimic the texture of the chicharrón snack are made from sea vegetables, such as kelp, arame, and kombu, but these also fail to provide for a complete source of protein and the overall texture and look of the product fall short of the traditionally known chicharrón. There remains a need for a snack food product having high quality protein while achieving the texture and taste of fried pork rinds.

### SUMMARY OF THE INVENTION

The present disclosure provides a composition and method for producing shelf-stable plant-based (i.e., meat-free) snacks comprising a texture resembling the meat-based snacks known as pork rinds or chicharrones.

In a first aspect, the method of making a snack food product by introducing a plant protein blend into an extruder to form an in-barrel mixture, the plant blend comprising a legume protein and a wheat gluten, a leavening agent and an aqueous solution; heating the in-barrel mixture in the extruder to form a melt; and extruding the melt through a die assembly to form an expanded extrudate, wherein the die assembly comprises a perforation plate and a forming die downstream from the perforation plate. In any of the above embodiments, the method further comprising cooking the expanded extrudate to form a snack food product comprising a crispy texture and a bubbled structure. In any of the above embodiments, the method further comprising seasoning. In any of the above embodiments, the plant protein blend comprises two parts legume protein and one part wheat gluten. In any of the above embodiments, the legume protein comprises a soy protein concentrate and a second legume protein. In any of the above embodiments, the leavening agent comprises sodium bicarbonate. Some embodiments comprising sodium bicarbonate comprise from 0.6 wt % to 1.6 wt % sodium bicarbonate on a dry basis. Some embodiments comprising from 0.8 wt % to 1.4 wt % on a dry basis. In any of the above embodiments, the legume comprises black bean, pinto bean, red bean, broad bean, mung bean, peanut, lentil, soybean, pea, chickpea, green bean, kidney bean, alfalfa, navy bean or mixtures thereof. In any of the above embodiments, the legume protein comprises a legume flour. In any of the above embodiments, the plant protein blend comprises up to about 90 wt % protein ingredients by weight on a dry basis. Each of the protein ingredients having about 70 to 85 wt % protein content by weight on a dry basis. For example, a “protein ingredient,” used herein may be a flour containing some amount of protein among other ingredients. In any of the above embodiments, the extruding step is free of a cooling zone. In any of the above embodiments, the forming die exit geometry comprises a die opening having a height to width ratio of 0.04 to 0.16. In any of the above embodiments, the perforation plate comprises a percent area open to flow of from 16 to 20%. Some embodiments, the perforation plate comprises a percent area open to flow of about 18%. In any of the above embodiments, the perforation die comprises a plurality of circular perforations having a diameter of from 2 to 4 mm. In any of the above embodiments, the cooking step is deep-frying at from 325° F. to 400° F. (163° C. to 204° C.) for from 1 to 5 minutes. In any of the above embodiments, the cooking step comprises deep frying. In any of the above embodiments, the cooking step consists of deep frying. In any of the above embodiments, the cooking step comprises air frying. In any of the above embodiments, the cooking step consists of air frying. In any of the above embodiments, the cooking step comprises air popping. In any of the above embodiments, the cooking step consists of air popping. In any of the above embodiments, further comprising freezing the expanded extrudate. In any of the above embodiments, the extruder comprises a twin-screw extruder. In any of the above embodiments, the extruder comprises a single screw extruder. In any of the above embodiments, where in the die opening is partitioned along a length of the die opening. In any of the above embodiments, the extrudate comprises a first porosity measurement; and the fried protein food product comprises a second porosity measurement, wherein the second porosity measurement is at least two times the value of the first porosity measurement. In any of the above embodiments, the second porosity measurement is from 2 to 3 times the value of the first porosity measurement. In any of the above embodiments, the in-barrel mixture comprises a moisture content of from 25 wt % to 31 wt %.

In a second aspect, an extrudate comprising a legume protein and a wheat gluten; a leavening agent; and from 18 wt % to 28 wt % moisture. In any of the above embodiments, the extrudate comprises from 0.6 to 1 wt % salt. In any of the above embodiments, the extrudate comprises from 1.7 to 2.6 wt % corn starch. In any of the above embodiments, the extrudate comprises from 1.5 to 3 wt % pea fiber. In any of the above embodiments, the extrudate comprises from 2.5 to 4 wt % sugar. In any of the above embodiments, the legume protein comprises pea protein flour and a second legume protein. In any of the above embodiments the legume protein comprises a soy protein concentrate and a second legume protein. In any of the above embodiments, the extrudate comprises a porosity of from 0.34 to 0.45 by volume.

In a third aspect, a fried protein food product comprising a legume protein flour; a wheat gluten flour, wherein the ratio of legume protein flour to wheat gluten flour by weight is about 2:1; a leavening agent; and from 1 wt % to 4 wt % moisture. In any of the above embodiments, the fried protein food product comprises from 35 wt % to 54 wt % legume protein flour. In any of the above embodiments, the fried protein food product comprises about 18 wt % to about 28 wt % oil content. In any of the above embodiments, the fried protein food product comprises about 17 wt % to about 26 wt % wheat gluten flour. In any of the above embodiments, the fried protein food product comprises about 0.6 wt % to about 1 wt % leavening agent. In any of the above embodiments, the fried protein food product comprises soy protein concentrate and pea protein in equal parts. In any of the above embodiments, the fried protein food product comprises a sweetener. For example, from 2.5 wt % to 3.75 wt % sugar. In any of the above embodiments, the fried protein food product comprises pea fiber. For example, from 1.8 wt % to to 2.7 wt % pea fiber. In any of the above embodiments, the fried protein food product comprises corn starch. For example, from 1.6 wt % to 2.5 wt % corn starch. In any of the above embodiments, the fried protein food product comprises sodium bicarbonate. In any of the above embodiments, the fried protein food product comprises seasoning. For example, from 0.6 wt % to 1 wt % salt. In any of the above embodiments, the fried protein food product comprises a crunchy texture. In any of the above embodiments, the fried protein food product comprises a porosity of from 1 to 1.4. In any of the above embodiments, the fried protein food product comprises a porous, bubbled structure. In any of the above embodiments, the legume protein flour comprises black bean, pinto bean, red bean, broad bean, mung bean, peanut, lentil, soybean, pea, chickpea, green bean, kidney bean, alfalfa, navy bean or mixtures thereof.

The foregoing is a brief summary of some aspects of exemplary embodiments and features of the invention. Other embodiments and features are detailed here below and/or will become apparent from the following detailed description of the invention when considered in conjunction with the accompanying drawings.

### BRIEF DESCRIPTION OF THE DRAWINGS

The novel features believed characteristic of the inventions are set forth in the appended claims. The figures presented here are schematic, not drawn to scale, and illustrate aspects of exemplary embodiments. In the figures, each identical or substantially similar component is represented by a single numeral or notation.

FIG. 1 is a flow chart depicting a method according to one embodiment of the present disclosure.

FIG. 2 is a schematic side view illustration of an exemplary apparatus used in making the snack food product described herein.

FIG. 3 is an end view of the perforation plate of a die assembly of an exemplary apparatus described herein.

FIG. 4A is an end view of the forming die having a single die opening that is located downstream of the perforation plate of an exemplary die assembly described herein.

FIG. 4B is an end view of an alternate forming die having a single die opening with partitions of an exemplary die assembly described herein.

FIG. 5 is an enlarged cross-sectional view of an exemplary embodiment of a snack food product of the present disclosure.

### DETAILED DESCRIPTION

To facilitate the discussion and description of various embodiments of the snack food product and method, descriptive conventions may be used to describe the relative position or location of the features, for example on the apparatus used in the method. For example, the terms “upstream” and downstream” will be used to describe the locations relative to a process path from the feed section of the extruder to the exit of the die. For example, embodiments of the process apparatus disclosed herein can include a process path of the raw materials upon entering the extruder through an upstream hopper end, then through several sequentially numbered barrels, through a perforation plate, then finally exiting downstream from the extruder through a forming die. Accordingly, the perforation plate may be described as downstream from the hopper but upstream from the forming die.

When used in the appended claims, in original and amended form, the term “comprising” is intended to be inclusive or open-ended and does not exclude any additional, unrecited element, method, step or material. Thus, the terms “including,” “comprising,” “having,” and variations thereof mean “including but not limited to,” unless expressly specified otherwise. The term “consisting of” excludes any element, step or material other than those specified in the claim. All numerical ranges included herein are inclusive of both end points and all numerical values that lie between both endpoints. The phrase “up to” includes zero as the lower limit and further includes the end point recited with the subject phrase.

An exemplary snack of the present disclosure is made from extruded wheat gluten and legume proteins, which are expanded, cooked, and seasoned to produce a product that resembles chicharrones. The method for making the snack of the present disclosure comprises the steps of providing a plant protein blend made up of wheat gluten and legume proteins; combining a leavening agent and aqueous solution to the plant protein blend to form an in-barrel mixture with moisture levels from 25 wt % to 31 wt % moisture. In another exemplary embodiment, the in-barrel moisture mixture comprises moisture levels from 29 wt % to 30 wt %. The present disclosure may be further understood by a consideration of the following definitions for terms as used herein.

The term “in-barrel mixture,” as used herein, refers to the contents of the extruder once the plant protein blend, leavening agent, and aqueous solution are added. For example, once all of the ingredients are added to the extruder and present in a predetermined composition, the contents of the extruder is considered an “in-barrel mixture”.

The term “melt,” as used herein, refers to the composition that results when the in-barrel mixture is heated and converted into molten state. For example, the melt is formed in the extruder and then passed into the die assembly prior to exiting the forming die 208.

The term “extrudate,” as used herein, refers to the composition that exits the forming die 208 into the atmospheric environment or into an optional cooling barrel 210 and out of the cooling barrel at 214. For example, the extrudate is the intermediate product resulting from the melt exiting the extruding process and prior to further frying or cooking.

The term “wheat gluten” (also referred to as gluten) refers to a protein made by washing wheat flour with water until almost all starches are dissolved and gluten remains. Gluten is known to include protein (including gliadins and glutenins) in an amount of from 50 wt % to 90 wt %, less than 20 wt % starch, and from 5 wt % to 7 wt % fat. In some embodiments, the gluten or wheat gluten comprises less than 10 wt % starch. In some embodiments, the wheat gluten comprises from 60 wt % to 90 wt % protein. In some embodiments, the wheat gluten comprises vital wheat gluten. In some embodiments, the wheat gluten consists of vital wheat gluten. In some embodiments, the wheat gluten comprises from 60 wt % to 80 wt % protein. In some embodiments, the wheat gluten comprises from 75 wt % to 80 wt % protein. Wheat gluten suitable for preparation of the plant protein blend may be in any dry form known in the art including without limitation flour, granules, flakes, clusters, powder, or any combination of such dry forms, for example. Gluten sources may be obtained from any number of manufacturers or sources. For example, an exemplary product made from wheat gluten flour is able to expand once extruded and hold more gas pockets. In addition, an exemplary embodiment with wheat gluten flour is less rubbery and more viscoelastic in texture than products made from proteins without wheat gluten flour.

As used herein, the term “pea protein” refers to one embodiment of a legume protein. The pea protein may be derived from whole pea or from a component of pea in accordance with methods generally known in the art. The pea may be standard pea, commoditized pea, genetically modified pea, or combinations thereof. The term “pea flour” typically includes at least 80 wt % pea protein on a dry-weight basis.

As used herein, the term “soy protein concentrate” is defined as a protein mixture derived from soybean having from 65 wt % to 90 wt % wet basis by weight protein. Soy protein concentrate is prepared by removing most of the water soluble, non-protein (e.g. carbohydrate) constituents from dehulled and defatted soybeans. Soy protein concentrate typically comprises 70 wt % protein, 20 wt % fiber, and may contain additional carbohydrates.

The term “leavening agent” refers to a substance that produces a foaming action that reduces the density or increases porosity of an extruded mixture. For example, a leavening agent may cause off gassing of air or carbon dioxide to create a porous structure within an extrudate. Examples of leavening agents include sodium bicarbonate and ammonium bicarbonate, and other leavening agents known in the industry. Leavening may also be achieved using mechanical means such as inject carbon dioxide or air into the process.

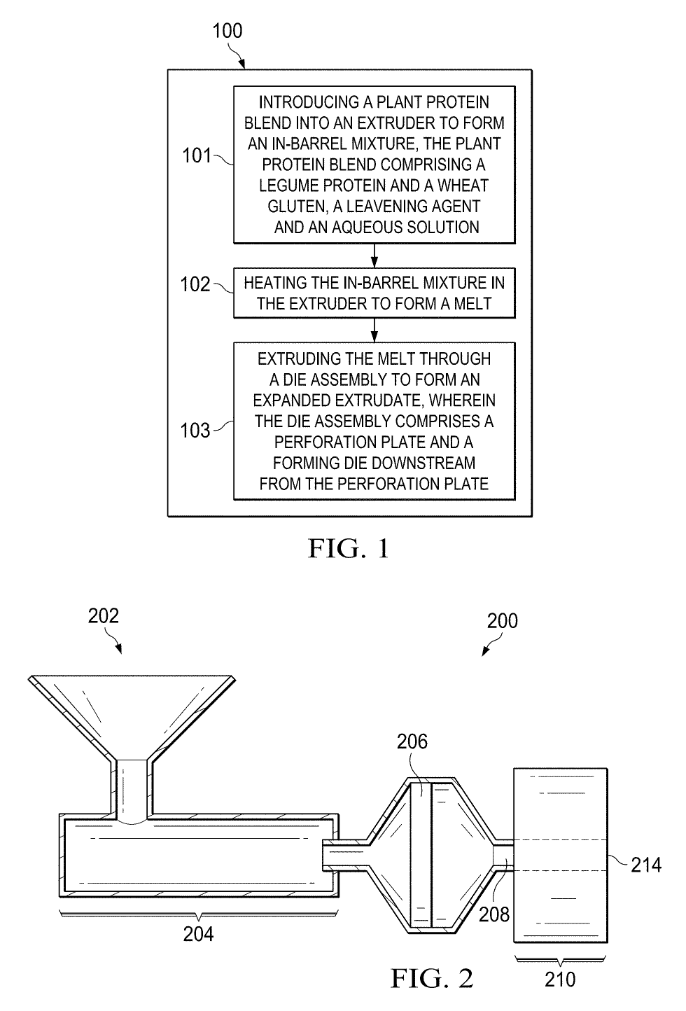

FIG. 1 is a flow chart depicting one embodiment of the method of making a snack food product as described herein. The method 100 comprising: introducing a plant protein blend into an extruder to form an in-barrel mixture, the plant protein blend comprising a legume protein and a wheat gluten, a leavening agent and an aqueous solution in step 101; heating the in-barrel mixture in the extruder to form a melt in step 102; and extruding the melt through a die assembly to form an expanded extrudate, wherein the die assembly comprises a perforation plate 206 and a forming die 208 downstream from the perforation plate 206 in step 103.

In the introducing step 101, the plant protein blend generally comprises a legume protein and a wheat gluten protein. In one embodiment, the plant protein blend further comprises fiber. For example, potential fiber that may be used include but are not limited to pea fiber, soy fiber, oat fiber, corn fiber, sugar cane fiber, and sugar beet fiber. In some embodiments, the legume protein comprises a single legume protein. In some embodiments, the legume protein comprises a second legume protein. In some embodiments, the legume protein comprises more than one legume protein. The legume protein may comprise pea protein, bean protein, chickpea protein, lentil protein, lupin bean protein, soy bean protein, or any combination thereof. In some embodiments, the legume comprises a pea protein. In some embodiments, the legume consists of a pea protein. In some embodiments, the legume comprises a bean protein. In some embodiments, the legume consists a bean protein. In some embodiments, the legume comprises a chickpea protein. In some embodiments, the legume consists of a chickpea protein. In some embodiments, the legume comprises a lentil protein. In some embodiments, the legume consists of a lentil protein. In some embodiments, the legume comprises a lupin bean protein. In some embodiments, the legume consists of a lupin bean protein. In some embodiments, the legume comprises a soybean protein. In some embodiments, the legume consists of a soybean protein. In some embodiments, the legume protein source comprises whole legume or fractions thereof. Any form of such proteins may be used, including without limitation, for example, flour, powder, agglomerates, granules, or flakes. In one embodiment, the plant protein blend has a moisture of up to 7 wt % moisture. In another embodiment, the plant protein blend has a moisture of up to 6 wt % moisture. In another embodiment, the plant protein blend has a moisture of from 4.6 to 6.9 wt % moisture by weight.

In some embodiments, the leavening agent comprises sodium bicarbonate. In some embodiments, the leavening agent consists of sodium bicarbonate. In some embodiments, the leavening agent comprises ammonium bicarbonate. In some embodiments, the leavening agent consist of ammonium bicarbonate. In other certain embodiments, the leavening agent comprises carbon dioxide, or other mechanical methods may be used in combination with chemical leavening. In some embodiments, the leavening agent comprises baking powder, baking soda, or any combination thereof. Other leavening agents known in the industry may be used in other embodiments. In some embodiments, the aqueous solution comprises water. In some embodiments, the aqueous solution comprises at least 90% water by weight. In some embodiments, the aqueous solution consists of water. The leavening agent may be added simultaneous with the aqueous solution or in sequence. In some embodiments, the leavening agent is added to the plant protein blend before the addition of the aqueous solution. In other embodiments, the leavening agent is added to the aqueous solution to form an aqueous solution of the leavening agent. For example, the aqueous solution with the leavening agent may be fed into the extruder separately from the plant protein blend to form an in-barrel mixture with a moisture of from 20 wt % to 36 wt %. In other embodiments, the moisture content of the in-barrel mixture is from 25 to 31 wt %. In other embodiments, the moisture content of the in-barrel mixture is from 29 to 30% by weight. In some embodiments, the leavening agent and the aqueous solution are added simultaneously with the plant protein blend into the extruder using three different inlets of entry. Other embodiments are possible as long as the appropriate moisture content, as described herein, is achieved.

Having formed the in-barrel mixture in the extruder in step 101 of FIG. 1, the in-barrel mixture is then heated in an extruder in step 102. FIG. 2 is a schematic side view illustration of an exemplary apparatus 200 with extruder 204. By way of example, a plant protein blend comprising wheat gluten and a legume protein is combined with leavening agent and conveyed into a hopper 202 to extruder 204 while an aqueous solution is fed separately into the extruder 204 to form the in-barrel mixture. In one embodiment, the plant protein blend comprises wheat gluten, a first legume protein and a second legume protein in substantially equal parts. The in-barrel mixture is then blended using a single or twin screw element and heated in the extruder 204 through a multiple barrel process.

In certain embodiments, the extruder 204 is a twin-screw extruder. In other embodiments, the extruder 204 is a single screw extruder. In another exemplary embodiment, the aqueous solution is added to the extruder 204 separately from the plant protein blend. In an exemplary embodiment, an aqueous solution is mixed with a leavening agent and added to the extruder separately from the plant protein blend. In another exemplary embodiment, the leavening agent is added to the plant protein blend and added to the extruder separately from the aqueous solution. The feed rates may vary depending on the extruder size. For example, larger extruders with larger screw diameters will have larger feed rates. The feed rates may also vary based on bulk density of the in-barrel mixture. Similarly, the extruder screw rates also depend upon feed rates and the attributes of the in-barrel mixture. In one embodiment, the extruder 204 operates at a screw speed of about 371 to 421 revolutions per minute. In an exemplary embodiment, the extruder 204 operates at a screw speed of about 396 revolutions per minute. In one embodiment, once the in-barrel mixture is heated and homogenized. The melt is then processed through a die assembly having a perforation plate 206 and a forming die 208.

Referring back to FIG. 2, once all of the components are added to the extruder 204, the in-barrel mixture is heated and homogenized in the extruder to form the melt as in step 102. In some embodiments, the extruder 204 may comprise one or more heating barrels aligned in series. In some embodiments, the extruder 204 may comprise 5 to 9 heating barrels. In some embodiments, the extruder 204 may comprise 6 heating barrels. The temperatures of each of the barrels may be set to gradually increase from barrel to barrel. The term “heating barrels” is also known in the industry as “cooking zones” or “cooking barrels” or “heating zones” or “melting zones.” For example, the heating barrels have both heating and cooling capabilities. In one embodiment, heating is introduced to each barrel. In another aspect of the embodiment, the last three barrels located closest to the die assembly are each set to a temperature set point of from 49° C. to 79° C. (120° F. to 175° F.). In another embodiment, the last three barrels located closest to the die assembly are each set to a temperature set point of from 57° C. to 66° C. (135° F. to 150° F.).

After the mixture is homogenized into a viscous melt, it is forced from the extruder screws (or screw) into a die assembly through a perforation plate 206 and exit a forming die 208. In an exemplary embodiment, the extruder die melt temperature is 120° C. to 160° C. (248° F. to 320° F.). The melt transitions to an extrudate once it exits the forming die 208. In one embodiment, the melt transitions to an extrudate once it enters the atmospheric environment after exiting the forming die 208. In another embodiment, the melt exits the forming die 208, transitions to an extrudate, and then enters a cooling barrel 210 and exits the cooling barrel 210 at a downstream opening 214. For example, the extruder 204 may optionally have one or more cooling barrels 210 connected in series downstream of the die assembly. In one embodiment, no cooling is added to any cooling barrels as part of the processing of the extrudate. In one embodiment, the temperature out of the forming die 208 is about 125° F. to 150° F. (52° C. to 66° C.). In some embodiments, cooling may be added to the cooling barrels in order to increase back pressure in order create any one or more of the features including cohesion, uniformity and porosity to the product.

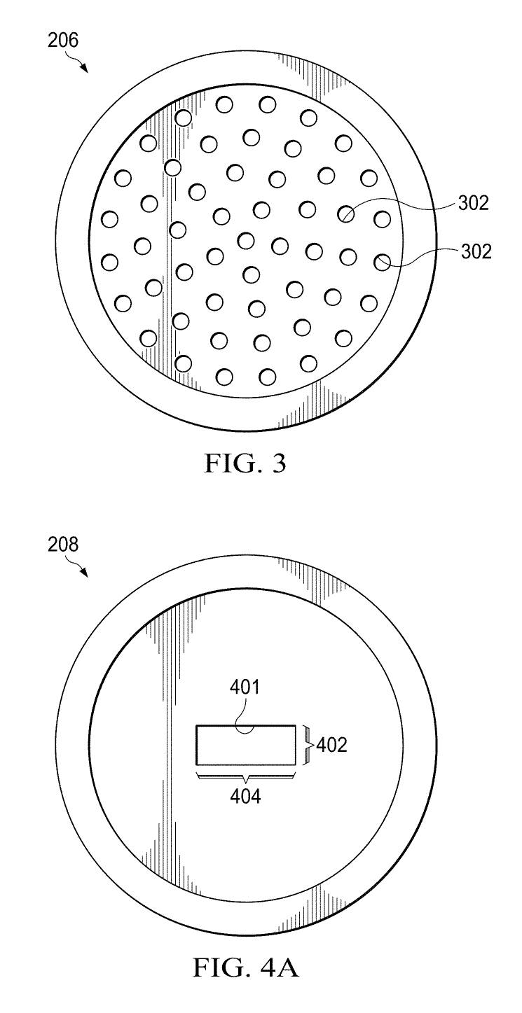

FIG. 3 is an end view of the perforation plate that forms part of the die assembly according to one embodiment. The perforation plate 206 comprises a number of open perforations 302 to create back pressure against the melt passing through the perforation plate 206. For example, each perforation may have an opening diameter of about 2 to about 5 mm. In another exemplary embodiment, each perforation may have an opening diameter of about 2.5 mm to 3 mm. In one embodiment the percentage of the perforating plate that is open for flow is about 18%. For example, the percentage of the perforating plate open for flow is a ratio of the perforation openings to the overall surface area of the perforation plate if there are no holes or openings present. The melt passes through the perforations in the perforation plate, reconsolidates and exits the die assembly through a forming die 208. By way of example and without intending to limit the invention, the perforation plate may comprise from 5 to 100 perforations. In one embodiment, the number of perforations is 51. In one embodiment, after passing through the perforation plate 206, the melt is fibrous in texture.

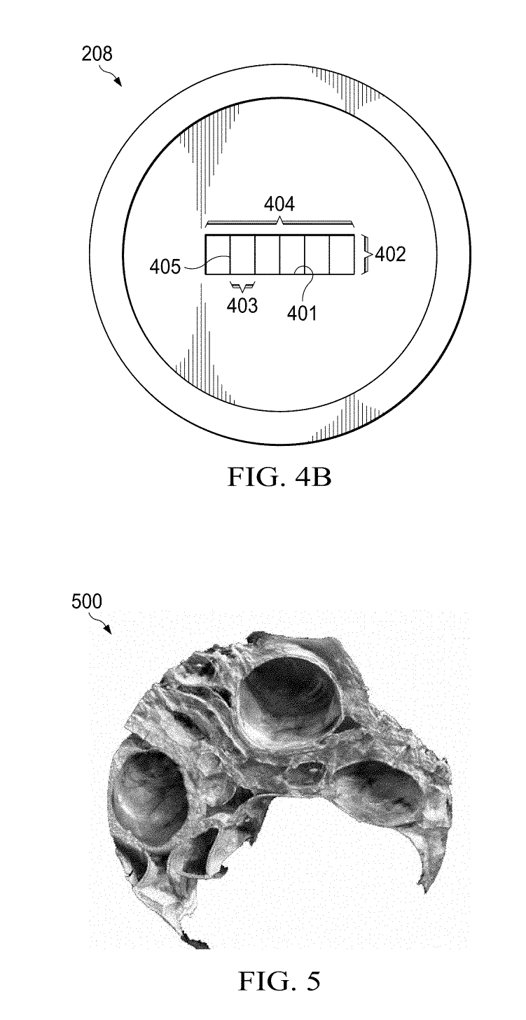

FIG. 4A is an end view of the forming die having a single die opening that is located downstream of the perforation plate. FIG. 4B is an end view of an alternate forming die having a single die opening with partitions. In the exemplary, non-limiting embodiments shown in FIGS. 4A and 4B, the die opening is shown to be an elongated opening. Other embodiments may include geometries comprising a square, rectangle, oval, circle, and other shapes.

In some embodiments, the forming die 208 comprises a single die opening 401 with dimensions 402 and 404. By way of example, the height 402 by width 404 ratio of the die opening may range from 0.04 to 0.16. In another embodiment, the height 402 by width 404 ratio of the die opening may range from 0.06 to 0.14. In some embodiments the die opening may be partitioned into a collection of smaller openings having a uniform width 403 so that extrudate passing through the die opening can be subjected to size reduction. By way of example, the resulting extrudate will have thickness 402 and a width 403. For example, the partitions 405 are used to divide the extrudate in the machine direction to a uniform product width as it exits the forming die. The term “machine direction” as used herein, describes the axis of the linear path in which the melt flows into the atmospheric environment and forms an extrudate. The term “cross-machine direction” as used herein, describes the axis perpendicular to the “machine direction.” In the absence of the partitions, extrudate exiting the die opening 401 would conform to the dimensions of the die opening, producing snack food pieces with undesirably large sizes.

The extrudate may also be divided in the cross-machine direction to a desired end product length using conventional cutting means, such as a reciprocating knife. Alternatively, the extrudate may be cooked prior to dividing the product in the cross-machine direction. Alternatively, the extrudate may be cooked prior to dividing the product in the cross-machine direction.

In one embodiment, the melt is processed through the die assembly before entering one or more cooling barrels. Such temperatures may help with product back pressure in the extruder to make flow more uniform. In another embodiment, no cooling occurs in the cooling barrel.

With reference to FIG. 1, following the extruding step 103, the melt expands upon exit from the forming die 208 to atmospheric pressure and ambient temperature. The extrudate expands, flashes vapor, cools and quickly solidifies into an expanded, fibrous, and tender extrudate with a bubbled, porous structure. Without being bound to any particular theory, it is believed that the expansion occurs due to gas production caused by the leavening agent when exposed to sufficient temperatures in the extruder. Furthermore, the expansion and bubbled, porous structure is increased when exposed to even more heat such as additional cooking or deep frying. For example, the extrudate may be cooked by pan frying, deep frying, air frying or air popping. In another aspect of some embodiments, the extrudate is deep fried using oils such as canola, canola and soy blend, vegetable blends, and other cooking oils known in the industry. For example, in one embodiment, the expanded extrudate is frozen, vacuum sealed, thawed, and deep fried for one to five minutes at a temperature of from 325° F. to 400° F. (177° C. to 204° C.). In another embodiment, the extrudate is brought to room temperature after extrusion prior to the deep-frying step. For example, the extrudate has a moisture content of from 18 wt % to 28 wt %. In another exemplary embodiment, the extrudate comprises a moisture content of from 20 wt % to 26 wt %.

FIG. 5 is an enlarged cross-sectional view of an exemplary embodiment of a snack food product of the present disclosure. For example, FIG. 5 depicts the product with interior voids or pores that result from to expansion after frying. For example, after frying, the product is further expanded with a moisture content of from 1 wt % to 4 wt %. In one embodiment, the cooked product is seasoned to a desired flavor. The final product is shelf stable and ready for consumption. In one embodiment, the cooked product has oil content in the range of 18% to 28% by weight. In another aspect of an embodiment, the calculated complete protein is 12 g per serving size of 28 g and protein digestibility-corrected amino acid score (PDCAAS) ˜0.82 and total protein of 14.6 g.

### Examples

During test runs, a plant protein blend was used comprising 29 wt % wheat gluten flour, 30 wt % pea protein flour, 30 wt % of a soy protein concentrate, 3 wt % corn starch, 4 wt % sugar, 1 wt % salt, and 3 wt % pea fiber. Sodium bicarbonate (leavening agent) was added to the plant protein blend and then into the feed hopper of a 32-mm diameter twin-screw extruder. The plant protein blend had a bulk density of 197 g/0.5 L and was introduced at a rate of 11.6 kgs/hr while the sodium bicarbonate was fed at a rate of 2.3 g/min as determined by a mass balance calculation. The aqueous solution was fed separately at a rate of 4 kg/hr to maintain an interior barrel moisture of 30% moisture by weight.

The first barrel following the hopper had a temperature set point of 60° C. (140° F.), the second barrel was set to a temperature of 90° C. (194° F.), the third barrel was set to a temperature of 135° C. (275° F.), the fourth and fifth barrels were set to 150° C. (302° F.), and the sixth was set to a temperature of 135° C. (275° F.). Moreover, the die melt temperature reached a temperature of 124° C. (255° F.). The term “die melt temperature,” as used herein, is the temperature of the melt just after the extruder screws and can be measured in the die assembly. The melt passed through a perforation plate 300 and converged through a forming die and exited to atmospheric pressure and ambient temperature at a rate of about 15.6 kg/hr for a 32-mm screw extruder. During the test run, the extrudate was frozen, vacuum sealed and transported. The frozen extrudate was thawed and then deep fried in canola oil for about two minutes at about 177° C. (350° F.). The resulting deep fried product is then seasoned with a savory flavoring to resemble chicharrones.

After the extrudate was frozen and vacuum sealed, it was transported to a facility for X-ray computed tomography imaging (μCT) where it was thawed and imaged. Void and solid volume percentages were calculated for the extrudate as shown in the first row of Table 1. For example, the extrudate had a solid volume of 72% and a void volume of 28%. Similarly, the extrudate was fried and then imaged 500 as shown in FIG. 5. For example, the deep fried product had a solid volume of 45% and a void volume of 55%. The void and solid percentages were calculated based on size measurements that were taken. Percentages were captured in the second row of Table 1. For example, the last column of Table 1 shows the void to solid ratio of both the extrudate and the deep-fried product. The ratio was shown to increase by 2 to 3 times once the extrudate was deep fried indicating a significant expansion and formation of the porous, bubbled structure. The term “bubbled structure,” as used herein, refers to the interior porous pockets of air formed inside of the product. For example, the cross-section of a product having a highly porous microstructure, or internal “bubbled structure” is shown in FIG. 5. The cross-section image FIG. 5, also shows the texture that gives the product crispy and crunchy attributes. The term “porosity,” as used herein, is the ratio of void to solid measurement by volume. For example, the porosity of the extrudate is 0.39 and the porosity of the deep-fried product is 1.2. An increased porosity value indicates an increased level of air pockets present in the sample.

TABLE 1

| | Solid Volume | Void Volume | Ratio Void:Solid |
|---|---|---|---|
| Extrudate | 72% | 28% | 0.39 |
| Deep Fried Product | 45% | 55% | 1.2 |

Although the present disclosure has provided many examples of systems, apparatuses, and methods, it should be understood that the components of the systems, apparatuses and method described herein are compatible and additional embodiments can be created by combining one or more elements from the various embodiments described herein. As an example, in some embodiments, a method described herein can further comprise one or more elements of a system described herein or a selected combination of elements from any combination of the systems or apparatuses described herein.

Furthermore, in some embodiments, a method described herein can further comprise using a system described herein, using one or more elements of a system described herein, or using a selected combination of elements from any combination of the systems described herein.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

Where language, for example, “for” or “to”, is used herein in conjunction with an effect, function, use or purpose, an additional embodiment can be provided by substituting “for” or “to” with “configured for/to” or “adapted for/to.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

As used herein, examples of “about” and “approximately” include a specified value or characteristic to within plus or minus 15, 10, 5, 4, 3, 2, or 1% of the specified value or characteristic.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of making a snack food product, said method comprising:
introducing a plant protein blend into an extruder to form an in-barrel mixture, the plant protein blend comprising a legume protein and a wheat gluten, a leavening agent and an aqueous solution;
heating the in-barrel mixture in the extruder to form a melt; and
extruding the melt through a die assembly to form an expanded extrudate, wherein the die assembly comprises a perforation plate and a forming die downstream from the perforation plate.

2. The method of claim 1 further comprising cooking the expanded extrudate to form the snack food product comprising a crispy texture and a bubbled structure.

3. The method of claim 1 wherein the plant protein blend comprises from 0.6% to 1.6% sodium bicarbonate by weight on a dry basis.

4. The method of claim 1 wherein the extruding step is free of a cooling zone.

5. The method of claim 2 wherein the cooking step is deep-frying at from 325° F. to 400° F. for 1 to 5 minutes.

6. The method of claim 2 wherein the cooking step comprises air popping.

7. The method of claim 2 wherein the extrudate comprises a first porosity measurement; and the fried protein food product comprises a second porosity measurement, wherein the second porosity measurement is at least two times the value of the first porosity measurement.

8. The method of claim 1 wherein the in-barrel mixture comprises a moisture content of about 25 wt % to about 31 wt %.

9. An extrudate comprising:
a legume protein and a wheat gluten;
a leavening agent; and
from 18 wt % to 28 wt % moisture.

10. The extrudate of claim 9 wherein the extrudate comprises a porosity of 0.34 to 0.45.

11. A fried protein food product comprising:
a legume protein flour;
a wheat gluten flour, wherein the ratio of legume protein flour to wheat gluten flour by weight is about 2:1;
a leavening agent; and
from 1 wt % to 4 wt % moisture.

12. The fried protein food product of claim 11 wherein the fried protein food product comprises from 35 wt % to 54 wt % legume protein flour.

13. The fried protein food product of claim 11 wherein the fried protein food product comprises from 17 wt % to 26 wt % wheat gluten flour.

14. The fried protein food product of claim 11 wherein the fried protein food product comprises from 0.6 wt % to 1 wt % leavening agent.

15. The fried protein food product of claim 11 wherein the legume protein flour comprises soy protein concentrate and pea protein in equal parts.

16. A The fried protein food product of claim 11 wherein the fried protein food product comprises from 1.8 wt % to 2.7 wt % pea fiber.

17. The fried protein food product of claim 14 wherein the leavening agent comprises sodium bicarbonate.

18. The fried protein food product of claim 11 wherein the fried protein food product comprises a crunchy texture.

19. The fried protein food product of claim 11 wherein the fried protein food product comprises a porosity of from 1 to 1.4.

20. The fried protein food product of claim 11 wherein the fried protein food product comprises a porous, bubbled structure.
